(19) United States
(12) Patent Application Publication
(10) Pub. No.: US 2024/0199290 A1
(43) Pub. Date: Jun. 20, 2024

(54) CHILD-RESISTANT LOCKING CONTAINER AND METHOD THEREOF

(71) Applicant: Sunshine Enclosures LLC, New York, NY (US)

(72) Inventor: Edward Ubell, New York, NY (US)

(73) Assignee: Sunshine Enclosures LLC, New York, NY (US)

(21) Appl. No.: 18/083,504

(22) Filed: Dec. 17, 2022

(51) Int. Cl. B65D 50/06

(52) U.S. Cl. CPC B65D 50/061; B65D 2215/04

(57) ABSTRACT

The container may comprise a lid, wherein the lid includes a lid sidewall, a lid top surface, and a lid aperture. The container may comprise a first member disposed within the lid, the first member affixed to the lid top surface, the first member comprising a first member sidewall, a first member top surface, and one or more indentations protruding below the first member top surface. Further, the container may comprise a second member disposed within the lid, the second member comprising a second member sidewall, a second member top surface, a second member threaded portion, and a cog disposed atop the second member top surface, the cog comprising one or more gaps between each of one or more teeth. Yet further, the container may comprise a body comprising a body sidewall, a body bottom surface, and a body threaded portion configured to reversibly engage the second member threaded portion.

### FIELD OF INVENTION

The invention of the present disclosure is in the field of storage containers, specifically containers designed with a child-resistant locking mechanism.

### INTRODUCTION

Storage containers are sought after for their convenience and ability to be utilized on an ongoing basis. Reusable storage containers decrease the need to seek out a new container every time there is something to be stored. This saves time, money, and decreases waste. However, this creates a need for reliable storage containers that can withstand repeated use. Individuals may rely on these storage containers to store food, medicine, office supplies, or any other good that may be organized.

Many reusable storage containers may employ an external locking mechanism where plastic flaps attached to the lid may lock into place on an outer lip of the container. Over time, the plastic may become warped, manifesting a lid that may not lock securely onto the container. Other reusable storage containers may utilize a ridge on the lid that locks into the container's lip, yet such containers may not provide suitable security. For example, should the container fall, there is nothing ensuring the container will not open, revealing the contents of the container. Further, these locking means are easily overcome by adults and children alike, which makes these containers undesirable when the contents should be inaccessible to children.

Accordingly, it would be desirable to provide a reusable container to employ a locking mechanism to ensure safety of its contents. Further, a container that may withstand the test of time may be desirable to decrease the need to continually seek out reusable storage containers. Moreover, it would be desirable to provide a container comprising child-resistant locking means. In particular, it may be desirable to provide a child-resistant container, wherein the locking mechanism is unobtrusive and/or non-obvious.

### SUMMARY

Additional aspects related to this disclosure are set forth, in part, in the description which follows, and in part, will be obvious from the description, or may be learned by practice of this disclosure.

It is to be understood that both the foregoing and the following descriptions are exemplary and explanatory only and are not intended to limit the claimed disclosure or application thereof in any manner whatsoever.

The invention of the present disclosure may be a container comprising a lid comprising a lid sidewall, a lid top surface. and a lid aperture. The container may further comprise a first member disposed within the lid, the first member may be affixed to the lid top surface. In an embodiment, the first member comprises a first member sidewall, a first member top surface, one or more indentations protruding below the first member top surface, and a first member aperture. The container may further comprise a second member disposed within the lid, where the second member may comprise a second member sidewall, a second member top surface, a second member threaded portion, and a cog disposed atop the second member top surface, the cog may comprise one or more gaps between each of one or more teeth. In an embodiment, the container further comprises a body comprising a body sidewall, a body bottom surface, and a body threaded portion configured to reversibly engage the second member threaded portion.

In an embodiment, the one or more gaps are sized to accept the one or more indentations. In a further embodiment, the container is configurable in a locked stated and an unlocked state, wherein the unlocked state comprises the one or more indentations within the one or more gaps, and wherein the unlocked state comprises the one or more indentations outside the one or more gaps. In the unlocked state, the lid may be adapted to transfer a rotational motion to the second member and the second member threaded portion.

The lid may include a lid diameter, wherein the lid diameter is greater than a first member diameter, and the first member diameter is greater than a second member diameter. Further, the lid may include a lid height, wherein the lid height is greater than a first member height. In yet a further aspect, the first member height may be greater than a second member height.

In an embodiment, the lid further comprises a lid retainer disposed circumferentially inward on the lid sidewall, wherein the lid retainer is configured to prevent at least the second member from escaping the lid. In another aspect, the body may further comprise a lip disposed between the body threaded portion and the body sidewall, wherein, in a closed position, the lip interfaces with the lid sidewall.

In one embodiment, the second member top surface further comprises a depression, wherein the depression surrounds the cog. The depression may reside below the cog and the depression and the cog may be parallel. In an aspect, the first member is affixed to the lid via an adhesive.

The body threaded portion may comprise a body threaded portion diameter, the body sidewall comprises a body sidewall diameter, and the body sidewall diameter may be greater than the body threaded portion diameter. The body sidewall diameter may be equivalent to a lid diameter and the body sidewall may be parallel with the lid sidewall. In an embodiment, at least the lid and the body are composed of a metal material.

### BRIEF DESCRIPTION OF DRAWINGS

The incorporated drawings, which are incorporated in and constitute a part of this specification exemplify the aspects of the present disclosure and, together with the description, explain and illustrate principles of this disclosure.

FIG. 1 is an exploded view of an embodiment of the container.

FIG. 2 is a schematic view of an embodiment of the container.

FIG. 3 is an inside view of an embodiment of a second member within a lid.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

The invention of the present disclosure may be a storage container configured to hold various items, including but not limited to food, medicine, and office supplies. In such an embodiment, the storage container may include a locking mechanism to ensure safety among users who the contents may pose a danger to (such as, but not limited to, young children and pets).

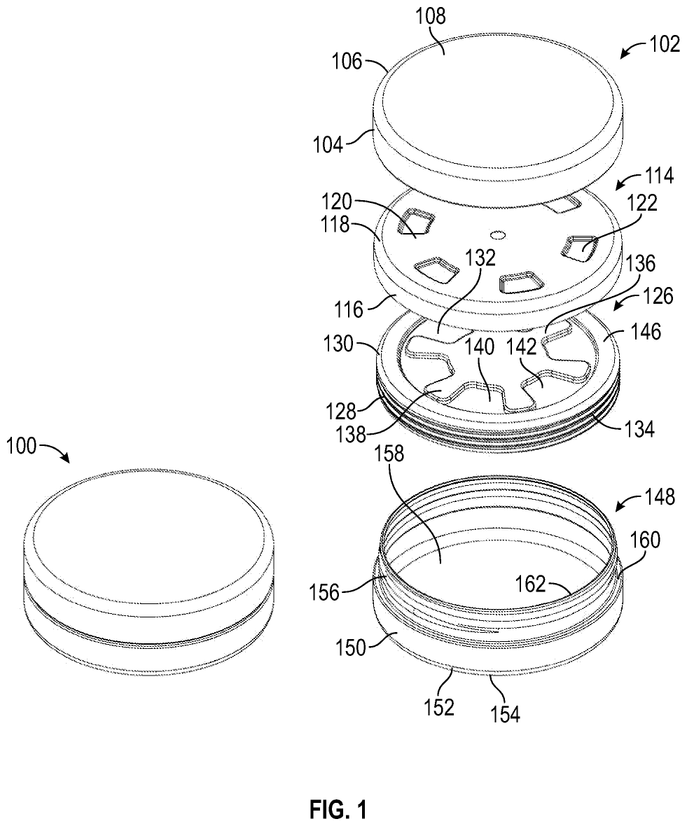

Referring to FIG. 1, the container 100 may comprise a lid 102, a first member 114, and a second member 126, and a body 148. In an embodiment, the container 100, and the aforementioned components, may be composed of metal such as, but not limited to, steel, aluminum, or iron, but may also be composed of non-metallic materials such as, but not limited to, plastic. In various embodiments, the various components of the container 100 may be composed of differing materials. For example, the body 148 and the lid 102 may be composed of metal, while the first member 114 and the second member 126 may be composed of plastic. However, any of the container 100 components may be composed of any combination of materials. In another embodiment, the container 100 may comprise one or more protective layers, for example, paint, lacquers, or other surface treatments. Such coatings may increase the resiliency of the container 100. In a further embodiment, the container 100 may be cylindrical in shape. However, the container 100 may be any suitable shape and/or dimensions.

In an embodiment, each of the container 100 major components: the lid 102, the first member 114, the second member 126, and the body 148, may be nestable and/or configured to create a child-resistant container. For example, the lid 102 may contain the first member 114 and the second member 126, wherein the second member 126 and the body 148 may reversibly interface to form the container 100.

The lid 102 may comprise a lid sidewall 104, a lid bevel 106, a lid top surface 108, and/or a lid retainer 110. The lid sidewall 104 may be an annular surface forming the outer perimeter of the lid 102. The lid top surface 108 may be a flat surface disposed atop the lid sidewall 104. In such an embodiment, the lid top surface 108 may be orthogonal to the lid sidewall 104. In a further aspect, the lid bevel 106 may be disposed between the lid top surface 108 and the lid sidewall 104. The lid bevel 106 may provide increased structural integrity to the lid 102 (for example, increasing the strength of the joinder between the lid top surface 108 and the lid sidewall 104). Further, the lid bevel 106 may be unobtrusive, smooth, and/or even to prevent sharp angles from causing discomfort to a user. Accordingly, as the lid top surface 108 may be disposed atop the lid sidewall 104, a lid aperture 112 may be formed traversing the bottom circumference of the lid sidewall 104. As described in further detail below, the lid aperture 112 may be sized to accept the first member 114 and/or the second member 126. However, in a further embodiment, the lid 102 includes a lid retainer 110, wherein the lid retainer 110 is sized as to capture the first member 114 and/or the second member 126 within the lid 102. The lid retainer 110 may be an annular member disposed on the inside surface of the bottom portion of the lid sidewall 104. Alternatively, the lid retainer 110 may be a portion of the lid sidewall 104 flared inward or otherwise angled/contorted to capture the first member 114 and/or the second member 126 within the lid 102.

The first member 114 may comprise a first member sidewall 116, a first member bevel 118, and/or a first member top surface 120. The first member sidewall 116 may be an annular surface forming the outer perimeter of the first member 114. The first member top surface 120 may be a flat surface disposed atop the first member sidewall 116. In such an embodiment, the first member top surface 120 may be orthogonal to the first member sidewall 116. In a further aspect, the first member bevel 118 may be disposed between the first member top surface 120 and the first member sidewall 116. The first member bevel 118 may provide increased structural integrity to the first member 114 (for example, increasing the strength of the joinder between the first member top surface 120 and the first member sidewall 116). Further, the first member bevel 118 may be sized complementary to the lid bevel 106. Accordingly, as the first member top surface 120 may be disposed atop the first member sidewall 116, a first member aperture 124 may be formed traversing the bottom circumference of the first member sidewall 116. In a further embodiment, the various bevels described herein (for example, those of the first member 114 and/the second member 126) may be sized to allow the first member 114 and the second member 126 to function given introduction of debris to the lid 102. In such a non-limiting example, debris accumulating between the first member 114 and the second member 126 may not prevent movement of the second member 126 because the bevels may distribute debris and reduce likelihood of impacted debris.

In an embodiment, the first member top surface 120 includes one or more indentations 122. The one or more indentations 122 may protrude below the first member top surface 120. For example, the one or more indentations 122 may be trapezoidal. The one or more indentations may be disposed radially on the first member top surface 120. Further, each of the one or more indentations 122 may be equidistant to adjacent indentations 122. The one or more indentations 122 may include a friction coating, such as rubber, to allow for securer interaction with the second member 126 as described below.

The first member 114 may include a first member aperture 124 size to accept at least the second member 126. Further, the first member 114 may be affixed to the lid 102. In one embodiment, the first member 114 may be adhered to the inside surface of the lid 102. Accordingly, after attachment, the first member 114 may be disposed in a fixed position within the lid 102.

The second member 126 may comprise a second member sidewall 128, a second member bevel 130, and/or a second member top surface 132. The second member sidewall 128 may be an annular surface forming at least part of the outer perimeter of the second member 128. The second member top surface 132 may be a surface disposed atop the second member sidewall 128. In such an embodiment, the second member top surface 132 may be orthogonal to the second member sidewall 116. In a further aspect, the second member bevel 130 may be disposed between the second member top surface 132 and the second member sidewall 128. The second member bevel 130 may provide increased structural integrity to the second member 126 (for example, increasing the strength of the joinder between the second member top surface 132 and the second member sidewall 128). Further, the second member bevel 130 may be sized complementary to the first member bevel 118 and/or the lid bevel 106.

The second member 126 may include a second member threaded portion 134. The second member threaded portion 134 may be an annular threaded surface disposed over or in conjunction with the second member sidewall 116. A second member aperture 144 may be formed traversing the bottom portion of the second member threaded portion 134 and/or second member sidewall 128.

The second member 126 may further include a cog 136 disposed on the second member top surface 132. The cog 136 may be a raised portion protruding normal above the second member top surface 132. The cog 136 may be disposed generally central to the second member top surface 132. In an embodiment, the cog 136 may include one or more teeth 138, wherein one or more gaps 140 are formed between adjacent teeth 138. The second member 126 may further include a depression 142. The depression 142 may surround the cog 136. The depression 142, the cog 136, the one or more teeth 138, and/or the one or more gaps 140 may be sized to interface and/or otherwise interact with the one or more indentations 122 of the first member 114. In alternate embodiments, the cog 136 and/or the one or more indentations 122 may be supplemented with any suitable shape and/or structure that induce the reversibly locking scheme described herein.

In an embodiment, the depression 142 may be bound by the rim 146, wherein the rim 146 is a raised annular portion disposed adjacent to the second member bevel 130. The rim 146 may be parallel to the surface of the cog 136 and/or the depression 142. Accordingly, the rim 146 may be orthogonal to the second member sidewall 128 and/or the second member threaded portion 134.

The body 148 may comprise a body sidewall 150, a body bevel 152, and/or a body bottom surface 154. The body sidewall 150 may be an annular surface forming at least part of the outer perimeter of the body 148. The body bottom surface 154 may be a surface disposed below the body sidewall 150. In such an embodiment, the body bottom surface 154 may be orthogonal to the body sidewall 150. In a further aspect, the body bevel 152 may be disposed between the body bottom surface 154 and the body sidewall 150. The body bevel 152 may provide increased structural integrity to the body 148 (for example, increasing the strength of the joinder between the body bottom surface 154 and the body sidewall 150). In one embodiment, the lid bevel 106 and the body bevel 152 may comprise the same shape and/or angle, such that both components exhibit similar appearances and tactile profile in a user's hand.

The body 148 may further include a body threaded portion 156 disposed atop the body sidewall 150. A chamber 158 may be bound by the body bottom surface 154, the body sidewall 150, the body bevel 152, the body threaded portion 156, and/or a body aperture 166.

In an embodiment, a lip 160 is disposed between the body sidewall 150 and the body threaded portion 156. The body threaded portion 156 may be recessed relative to the body sidewall 150. For example, the body threaded portion 156 may have a diameter less than that of the body sidewall 150.

The lid sidewall 104, the lid bevel 106, the lid top surface 108, the first member sidewall 116, the first member bevel 118, the body sidewall 150, the body bevel 152, and/or the body bottom surface 154 may have smooth surfaces. In an alternate embodiment, the lid sidewall 104, the lid bevel 106, the lid top surface 108, the first member sidewall 116, the first member bevel 118, the body sidewall 150, the body bevel 152, and/or the body bottom surface 154 may include etchings or features on the outer surface, including but not limited to ridges, raised designs, or imprinted designs. Any component of the container 100, for example, those exposed to the environment, such as the lid sidewall 104, the lid bevel 106, the lid top surface 108, the first member sidewall 116, the first member bevel 118, the body sidewall 150, the body bevel 152, and/or the body bottom surface 154, may include a textured surface configured to increase friction with a grasping member. For example, the outer surfaces of the container 100 may include a granular textured coating or layer to prevent slipping and promote a secure grip.

In an embodiment, the major components (the lid 102, the first member 114, the second member 126, and the body 148) of the container 100 may be formed of the same material. However, in an alternate embodiment, each of the components of the container 100 may be composed of any suitable material, or combination of materials. For example, the lid 102 and the body 148 may be formed from the same type of metal, while the first member 114 and the second member 126 are formed of polymer or plastic.

In an embodiment, the second member threaded portion 134 and the body threaded portion 156 may be complementary, such that the lid 102 and the body 148 can be linked. Particular actuation and/or manipulation of first member 114 relative to the second member 126 may permit separation of the lid 102 from the body 148. Accordingly, the second member 126 and/or the first member 114 may be manipulated indirectly, via direct manipulation of the lid 102 and/or body 148. For example, one or more particularized motions may permit removal of the lid 102 from the body 148.

The second member threaded portion 134 may comprise a second member threaded portion thread count and thread pitch. The body threaded portion 156 may have a body threaded portion thread count and thread pitch. The count and pitch of each of the aforementioned threaded sections 134/156 may be complementary to enable coupling of the body threaded portion 156 to the second member threaded portion 134.

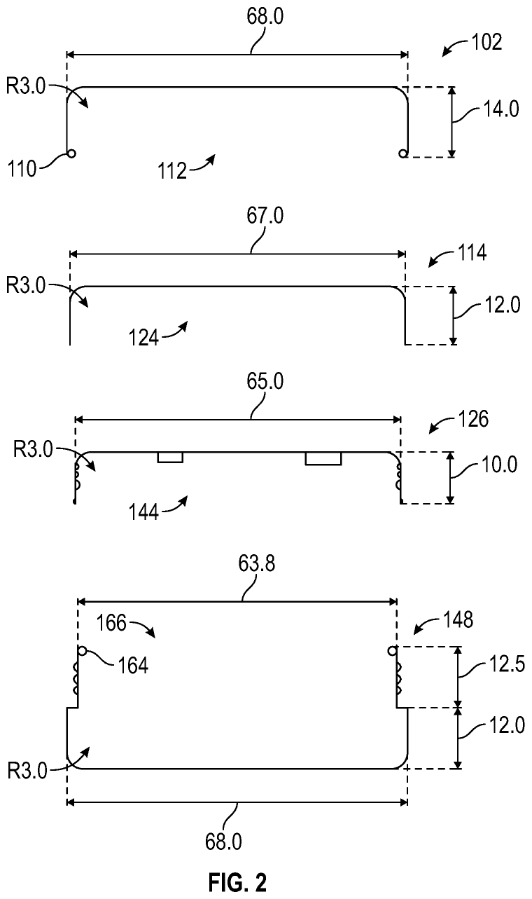

Referring to FIG. 2, the lid 102 may have an outer diameter greater than the outer diameters of the first member 114 and/or second member 126. The lid 102 may include an outer diameter equivalent to that of the body 148. The first member 114 may have an outer diameter greater than the outer diameter of the second member 126. In one embodiment, the lid 102 may have a diameter of 68 mm, the first member 114 may have a diameter of 67 mm, the second member 126 may have a diameter of 65 mm, the body aperture 166 may have a diameter of 63.8 mm, and the body sidewall 150 may have a diameter of 68 mm.

The lid 102 may have a height greater than the heights of the first member 114 and the second member 126. In one embodiment, the lid 102 may have a height of 14 mm, the first member 114 may have a height of 12 mm, the second member 126 may have a height of 10 mm, the body threaded portion 156 may have a height of 12.5 mm, and the body sidewall 150 may have a height of 12 mm.

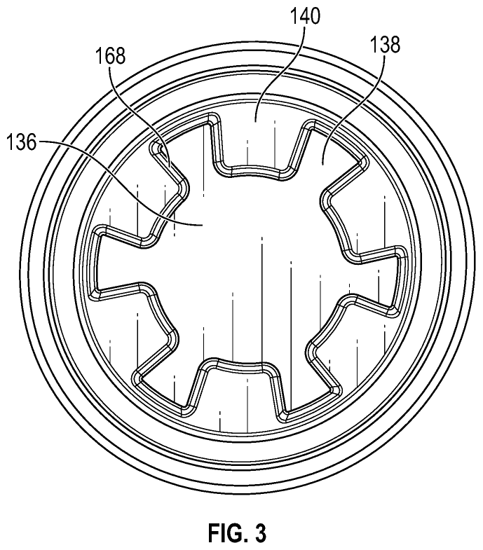

FIG. 3 exemplifies an inside view of an embodiment of the second member 126. In an alternate embodiment, any suitable shape may be used in the place of the cog 136. The cog 136 may be centered on the second member top surface 132. However, the cog 136 may be any suitable diameter and may be positioned in any suitable location on the second member top surface 132. The cog 136 may include a large footprint (relative to the second member 126) as to promote a positive interface between the cog 136 and the one or more indentations 122. Moreover, inclusion of a plurality of indentations 122 and a plurality of teeth/gaps 138/140 may distribute wear across the plurality of said components. Conversely, utilization of a singular indentation and a singular gap may increase likelihood of failure and wear.

The container 100 may be configurable in a locked state and an unlocked state. In a locked state, the body threaded portion 156 may be engaged with the second member threaded portion 134 and/or the one or more indentations 122 may not be disposed within the one or more gaps 140. Thus, the second member 126 may be floating, yet captured, between the lid retainer 110 and the first member 114. Accordingly, in the locked state, as the one or more gaps 140 are not filled by the one or more indentations 122, rotational motion of the lid 102 will not cause the second member 126 to rotate. Thus, without movement of the second member 126, the second member threaded portion 134 may not be unthreaded from the body threaded portion 156.

In an embodiment, in an unlocked state, the one or more indentations 122 may be disposed between the one or more gaps 140. Thus, in the unlocked state, rotational motion imparted on the lid 102 may result in separation of the second member threaded portion 134 from the body threaded portion 156. In one embodiment, as the second member may be shorter than the first member 114 and the lid 102, a user may impart downward pressure on the lid 102, causing the first member top surface 120 to interface with the second member top surface 132. Therefore, in such a scenario, the one or more indentations 122 may fill the one or more gaps 140 (or may be made to do so with a minor rotation). Thus, in a sealed position and a locked state, the lid 102 may freely rotate without permitting the threaded portions 134/156 to unengage.

In order to open the container 100, a user may first convert the container 100 into the unlocked state. For example, the user may apply pressure on the lid 102, such that the lid 102 approaches the body 148, bringing the one or more indentations 122 in close proximity to the second member top surface 132. In such an instance, (1) the one or more indentations 122 may enter the one or more gaps 140; or (2) the one or more indentations 122 may contact the second member top surface 132, for example, along the one or more teeth 138. If the one or more indentations 122 contact the one or more teeth 138 instead of the one or more gaps 140, the user may impart minor rotation to the lid 102, causing the one or more indentations 122 to rotate, allowing the one or more indentations to enter the one or more gaps 140. As a non-limiting example, in such an instance, a downward pressure may also be applied. In an instance where the teeth 138 initially contact the indentations 122, the lid 102 may require rotation equivalent to roughly the arc of one indentation 122 to position the one or more indentations 122 in the one or more gaps 140. If the container 100 is in the unlocked state, the user may rotate the lid 102, causing the first member 114 and the one or more indentations 122 to rotate, further causing the second member 126 and the one or more gaps 140 to rotate, yet further initiating the separation of the second member threaded portion 134 from the body threaded portion 156. In one embodiment, pressure must be maintained throughout all aspects of the removal process. In another embodiment, pressure may be relieved once the second member threaded portion 134 and the body threaded portion 156 have separated by a suitable distance.

In a further embodiment, referring to FIG. 3, the second member 126 includes an incline 168 surrounding the perimeter of the cog 136. The incline 168 may be an incline, angled, and/or curved wall joining the cog 136 to the depression 142. Accordingly, the incline 168 may promote simpler indexing of the one or indentations 122 with the one or more gaps 140. For example, the incline 168 may be flared and/or tapered as to allow the one or more indentations 122 to “slide” into the one or more gaps 140.

While this invention has been described in conjunction with the embodiments outlined above, many alternatives, modifications and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

What is claimed is:

1. A container comprising:
a lid comprising:
a lid sidewall;
a lid top surface; and
a lid aperture;
a first member disposed within the lid, the first member affixed to the lid top surface, the first member comprising:
a first member sidewall;
a first member top surface;
one or more indentations protruding below the first member top surface; and
a first member aperture;
a second member disposed within the lid, the second member comprising:
a second member sidewall;
a second member top surface;
a second member threaded portion; and
a cog disposed atop the second member top surface, the cog comprising one or more gaps between each of one or more teeth; and
a body comprising:
a body sidewall;
a body bottom surface; and
a body threaded portion configured to reversibly engage the second member threaded portion.

2. The container of claim 1, wherein the one or more gaps are sized to accept the one or more indentations.

3. The container of claim 2, wherein the container is configurable in a locked stated and an unlocked state, wherein the unlocked state comprises the one or more indentations within the one or more gaps, and wherein the unlocked state comprises the one or more indentations outside the one or more gaps.

4. The container of claim 3, wherein, in the unlocked state, the lid is adapted to transfer a rotational motion to the second member and the second member threaded portion.

5. The container of claim 4, wherein a lid diameter is greater than a first member diameter, and the first member diameter is greater than a second member diameter.

6. The container of claim 5, wherein a lid height is greater than a first member height.

7. The container of claim 6, wherein the first member height is greater than a second member height.

8. The container of claim 1, the lid further comprising a lid retainer disposed circumferentially inward on the lid sidewall, the lid retainer configured to prevent at least the second member from escaping the lid.

9. The container of claim 1, the body further comprising a lip disposed between the body threaded portion and the body sidewall, wherein, in a closed position, the lip interfaces with the lid sidewall.

10. The container of claim 1, the second member top surface further comprising a depression, wherein the depression surrounds the cog.

11. The container of claim 10, wherein the depression resides below the cog and the depression and the cog are parallel.

12. The container of claim 1, wherein the first member is affixed to the lid via an adhesive.

13. The container of claim 1, wherein the body threaded portion comprises a body threaded portion diameter, the body sidewall comprises a body sidewall diameter, and the body sidewall diameter is greater than the body threaded portion diameter.

14. The container of claim 13, wherein the body sidewall diameter is equivalent to a lid diameter and the body sidewall is parallel with the lid sidewall.

15. The container of claim 1, wherein at least the lid and the body are composed of a metal material.
